(19) United States
(12) Patent Application Publication
(10) Pub. No.: US 2007/0245611 A1
(43) Pub. Date: Oct. 25, 2007

(54) SNAP-ON LABEL HOLDER FOR A METAL SHELF

(75) Inventor: Byron K. McDonald, Vancouver (CA)

Correspondence Address: OYEN, WIGGS, GREEN & MUTALA LLP;480 - THE STATION, 601 WEST CORDOVA STREET, VANCOUVER, BC, V6B 1G1, US

(73) Assignee: KOST KLIP MANUFACTURING LTD., Port Coquitlam (CA)

(21) Appl. No.: 11/736,712

(22) Filed: Apr. 18, 2007

(30) Foreign Application Priority Data
Apr. 21, 2006 (CA) 2547507

(51) Int. Cl. G09F 3/18

(52) U.S. Cl. 40/661.03

(57) ABSTRACT

A snap-on label holder adapted for direct mounting to the front edge of a shelf. The label holder has a hingeable front pocket member interconnected by a flexible hinge to a hook-shaped rear mounting member. The rear mounting member profile defines an interior region flanked between two opposite jaws adapted to be snapped-on to the shelf edge. The interior region includes a sinuous-shape profile that acts both as a spring-bias means providing an improved snap-on function and as a fulcrum against which front pocket member bottom can be pressed on to open the pocket front panel. In a second and third embodiments of the invention, the front pocket member integrates respectively a sign clip in its back panel or a gripper in its front panel. Shelves to snap-on include Hussmann-like, metal wire Metro-like, wooden or plastic shelves.

### FIELD OF THE INVENTION

This invention pertains to the field of label holders used in retail stores and supermarkets, and in particular, to label holders for direct mounting to a shelf.

### BACKGROUND OF THE INVENTION

Typically, label holders for store shelves are provided with means for displaying price and other information relating to the products on display. This becomes particularly a problem in grocery stores, where price and product information have to be changed very frequently. Accordingly, it has been recognized that it is desirable to provide a means whereby labels are removably retained for display at the shelf edge. In order to address this need, shelves placed in cabinets have been provided with a hook-shaped channel along their exposed outer edge, referred to as a price ticket channel. Typical store shelves made of metal, plastic or wood include the Hussmann™ shelf which is provided with an extruded aluminum price channel mounted to the shelf.

Where traditional price ticket channels were used, a card or a label was taped or retained directly within the channel. However, this approach leaves the labels open to switching or other tampering by customers. As well, this traditional method requires the use of an expensive rigid material for both the extruded aluminum price channel and for the label in order to achieve a firm retention within the channel.

These requirements are expensive to meet and may be incompatible with the computer-generated labeling system in use in many stores. Accordingly, it is desirable to mount directly a label holder to a shelf edge without requiring to mount an extruded price channel to the shelf. It is also desirable to place labels behind a label holder, to render them more difficult to tamper with and allow for the use of paper labels. As well, it is desirable to provide a system that accommodates labels of any heights. Furthermore, it is desirable that the label holder be easily fixed to the shelf.

Various systems have been proposed to provide a clear covering or holder for labels to eliminate the need to tape labels directly to shelves and still protect the labels from tampering. For example, Ostrovsky teaches in U.S. Pat. No. 5,473,833 a clip-on price ticket channel cover for a metal shelf that can display small size labels unless expensive C-channels are mounted to various metal or wood shelf models to make them suitable to display the proposed label holder. Other systems use a simple plastic panel that is removably inserted into the C-channel, typically by sliding the panel into the channel from one end. A drawback of this approach is the difficulty and awkwardness of installing and removing the panels without disturbing the labels, whether to change the labels or to replace the panel when it becomes damaged.

Generally, it is desirable that the label holder be mountable directly to a shelf edge without requiring the need to use an intermediary aluminum extruded price channel in-between the metal or wood shelf edge and the label holder. This would provide a technical improvement and a cost reduction when compared to prior art disclosed in European Pat. 0511468 A1, in U.S. D510,602 S and in U.S. D425,566 which have little or no spring-bias means built into their rear hook-shaped mounting portion thus are prone to shape deformation when snapped-on to a shelf, and furthermore, are configured to display small signs only.

Furthermore, it is desirable that the label holder be made as a single-piece strip mountable directly to a shelf, thus not requiring an assembly of two separate pieces cooperating together such as disclosed in U.S. Pat. No. 5,263,269 and U.S. Pat. No. 6,935,061 B2.

In addition any modification required to any one of the aluminum or plastic extruded channels installed on any shelf level should not require the removal of that shelf level from an enclosed environment such as for shelves installed in refrigeration cabinets. And finally, mounting a label holder to a shelf should not cause it to deform and affect label readability as seen in numerous label holders of prior art such as in patents CA 2361025, CA 2271433, U.S. Pat. No. 6,105,295, U.S. Pat. No. 6,470,613 B1, U.S. D510,602 S and DE 3513199 A1.

Furthermore, when dealing with shelf systems that are located in an enclosed environment such as a cooler or a refrigeration display cabinet of the Hussmann-type, sliding an extruded aluminum price channel or a rigid label holder into the channel from its end is not possible, unless the entire shelf is taken out of the cabinet.

Accordingly, it is desirable to place labels inside a label pocket, to render it more difficult to tamper and allow for the use of paper labels. As well, it is desirable to provide a system that allows all sizes of labels to be easily fixed to the shelf.

Furthermore, a label holder intended for use inside a refrigeration unit faces several other requirements. It must be simple to manufacture, to install, and to replace. Replacement of labels must be easy and rapid. To address these requirements, Valiulis disclosed in U.S. D485,582 S a hinged label holder with a channel. However, this label holder can be positioned on the shelf only after sliding said holder channel into a mating extruded price channel from one of the channel ends. In addition, no residual spring effect is provided to snap-on this label holder to a metal shelf.

Furthermore, a label holder should be relatively tamper-proof. Since a label holder typically comprises an elongate strip that extends the length of the shelf and holds many labels, it should firmly hold each label independently of its neighbors. It should allow for the insertion of a variety of types and sizes of labels and displays in addition to standard data strips, for example larger and higher displays that do not interfere with easy pull out of merchandise.

Finally, a label holder should be adapted to be snapped-on to a metal shelf, its label pocket be easily openable when exerting a localized pressure on the bottom portion of the label holder. The label holder should be readable by a bar code scanner when held in the holder.

### OBJECTS OF THE INVENTION

An object of the present invention is to provide a label holder that may be snapped-on directly to any metal, wood or plastic platform edge such as of a Hussmann-like shelf, a wire shelf or a wood shelf and be capable of releasably retaining a paper label while avoiding costs associated with installation of extra extruded aluminum or plastic price channels that come standard with many shelves such as, for example, a Hussmann shelf.

Another object of the invention is to provide a label holder that is relatively simple to manufacture, install, replace, and use, and that securely holds a sign on a shelf edge without being subject to any deformation.

Another object of the invention is to provide a snap-on sign holder that can hold signs of any heights and sizes.

Yet another object of the invention is to provide a snap-on label holder having two members interconnected flexibly to each others, a first snap-on mounting member and a second pocket member comprising a front display panel interconnected with a back support panel having a sign clip integrally joined into it. This label holder is able to provide support to both a large auxiliary sign card and a conventional price-label, both being displayed together without obstructing the other.

Still another object of the invention is to provide a snap-on label holder having two members interconnected flexibly to each others, a first snap-on mounting member and a second pocket member comprising a front display panel having an upper sign clip integrally joined into its front clear window panel. This label holder is able to provide support to both a large auxiliary sign card and a conventional price-label.

### SUMMARY OF THE INVENTION

It is an object of the invention to remove or reduce the drawbacks of prior art label holders that snap-on to a shelf and more particularly to a metal wire, a Hussmann-like metal shelf or to a wood shelf and to provide an improved label holder of this kind.

In accordance with a first embodiment of the present invention, a new and improved label holder is provided for mounting on a metal or wood shelf and more particularly to label holders to be installed on a metal wire shelf, a Hussmann-type shelf such as used in enclosed environments like in a refrigeration casing and on a wood shelf. A Hussmann™ shelf is generally provided with an extruded aluminum or plastic price channel that is generally bolted or otherwise mounted to the edge of each of Hussmann™ metal shelf platforms.

Label holders for metal shelves located in enclosed and confined environments such as in refrigerated cabinets, require to be easily installed and be functional enough to be able to readily receive, display or remove labels in an effective manner while remaining cost-effective.

In a first embodiment of the invention, the label holder of the invention is typically co-extruded from resilient plastic materials and comprises a front pocket member interconnected by a resilient hinge to a hook-shaped rear mounting member which can be simply snapped-on to the front edge of a shelf such as a metal Hussmann™ shelf, a wire shelf or a wood shelf, said mounting member being configured like a pair of opposing jaws. Added resiliency is provided by a nose-shaped spring-bias means built-in into the profile of the hook-shaped mounting member.

The front pocket member may be extruded to any desirable height for providing maximum exposure and visibility. Restrictions on height are eliminated because the label holder is provided with an upper flexible hinge that allows the front pocket member to hinge and provide easy access to merchandise placed behind the label holder despite height of the label holder.

The rear mounting member is adapted for snap-on engagement to the longitudinal front edge of a shelf and has a hook-shaped interior region that is configured in shapes selected from the group consisting of a protruded nose-like shape, a U-shape, a W-shape, a C-shape, a square wave-shape and shapes of the like that extend inwardly and outwardly from said interior region. Said shapes provide two functions, a first spring-bias means that biases jaws and of said rear mounting member towards the shelf edge and second forms a fulcrum in relation to the front label pocket member.

The fulcrum effect is best utilized when the front clear panel is urged open by directing downward and/or rearward pressure on the bottom portion of the label holder against the fulcrum. This fulcrum effect facilitates insertion and replacement of labels (not shown) within the label pocket.

In a second embodiment of the invention, the label holder has the same hook-shaped rear mounting member as in first embodiment, said rear mounting is also interconnected by a same resilient hinge to a same front pocket member, with exception that in this embodiment, the label holder front pocket member further comprises a sign clip integrally joined in its back. This embodiment of the label holder provides support to both a large auxiliary sign card and a conventional price-label, both being displayed together without obstructing the other.

In a third embodiment of the invention, the label holder has the same hook-shaped rear mounting member as in first embodiment, is also interconnected by a same resilient hinge to a same front pocket member, but in this embodiment, the label holder front pocket member further comprises a sign clip integrally joined in its front upper edge. This embodiment of the label holder provides support to both a large auxiliary sign card and a conventional price-label.

Thus, the label holder of the present invention provides an improved label holder for mounting information labels directly on a shelf edge such as on a metal wire, a Hussmann-like metal shelf or a wooden shelf without requiring pre-installation of an extruded aluminum or plastic price channel. The label holder also accommodates label pockets of various heights and sizes with its display pocket able to open simply by applying pressure to a bottom portion of the label holder. Furthermore, the label holder comprises in other embodiments of the invention, a sign clip that is positioned in the back or in the front of the front pocket member.

### BRIEF DESCRIPTION OF THE DRAWINGS

FIG. 1 is a sectional view of a first embodiment of the device attached to a Hussmann-like metal shelf;

FIG. 2 is a sectional view of prior art label holder mounted to an extruded channel engaged to a Hussmann-like metal shelf;

FIG. 3 is a perspective view of a portion of the label holder;

FIG. 4 is a sectional view of the label holder with the rear mounting member engaged to a Hussmann-like metal shelf and the front member hinged upwardly;

FIG. 5 is a sectional view of the first embodiment of the label holder;

FIG. 6 is a front view of a portion of the label holder;

FIG. 7 is a sectional view of the label holder, mounted to a Hussmann-like metal shelf, being pressed open by a finger;

FIG. 8 is a sectional view of the second embodiment of the label holder with a back sign clip integrally joined to the back side of the front pocket member;

FIG. 9 is a sectional view of the second embodiment of the label holder of FIG. 8 with a sign being inserted into the back sign clip;

FIG. 10 is a sectional view of the third embodiment of the label holder mounted on a metal wire shelf, the label holder having a front upper gripper;

FIG. 11 is a sectional view of the third embodiment of the label holder mounted on a wooden shelf;

FIGS. 12, 13, 14, 15, 16 and 17 show sectional views of various configurations of rear mounting member of the label holder; and

FIGS. 19 and 20 are sectional views of the prior art label holder of FIG. 18 showing how the mounting member becomes deformed when engaged with a price channel.

### DETAILED DESCRIPTION OF THE PREFERRED EMBODIMENTS

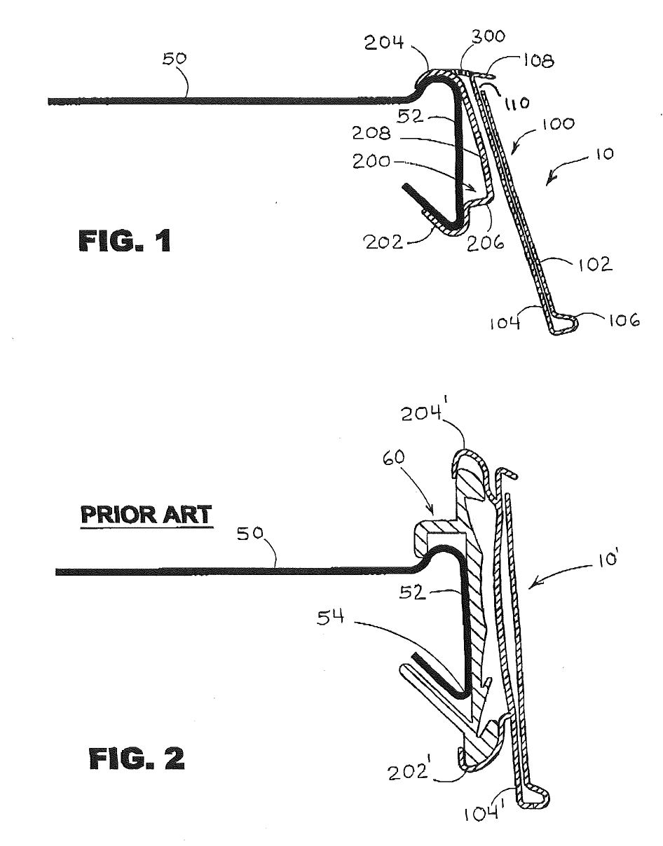

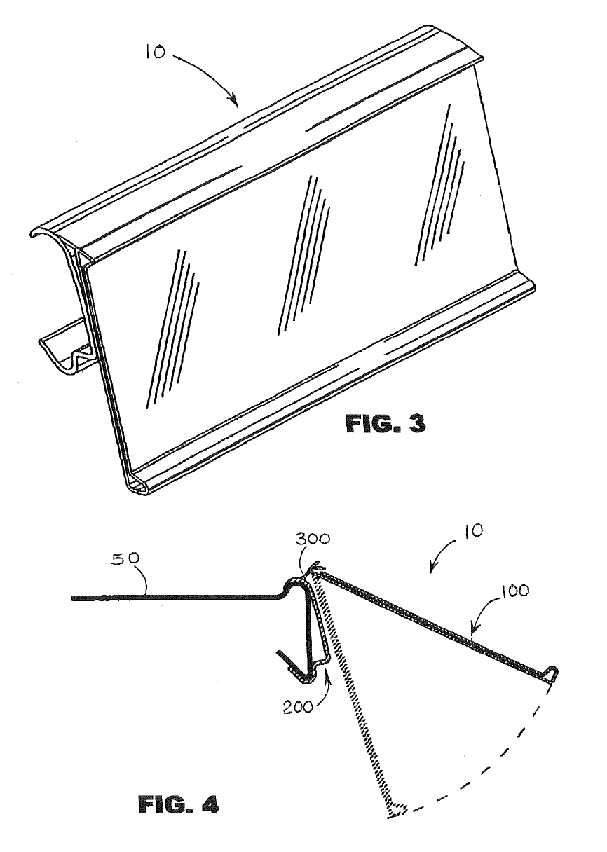

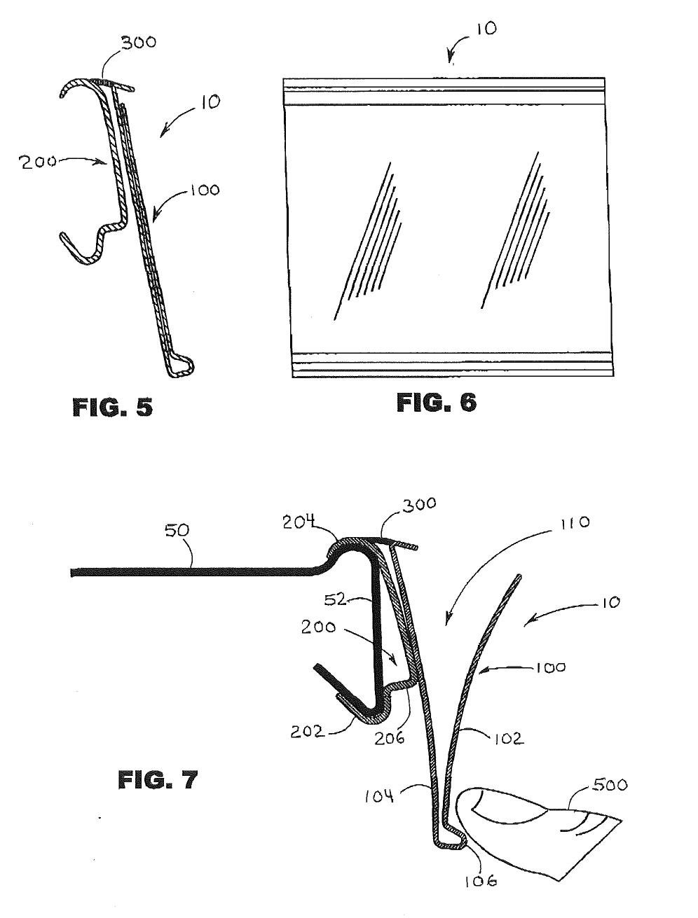

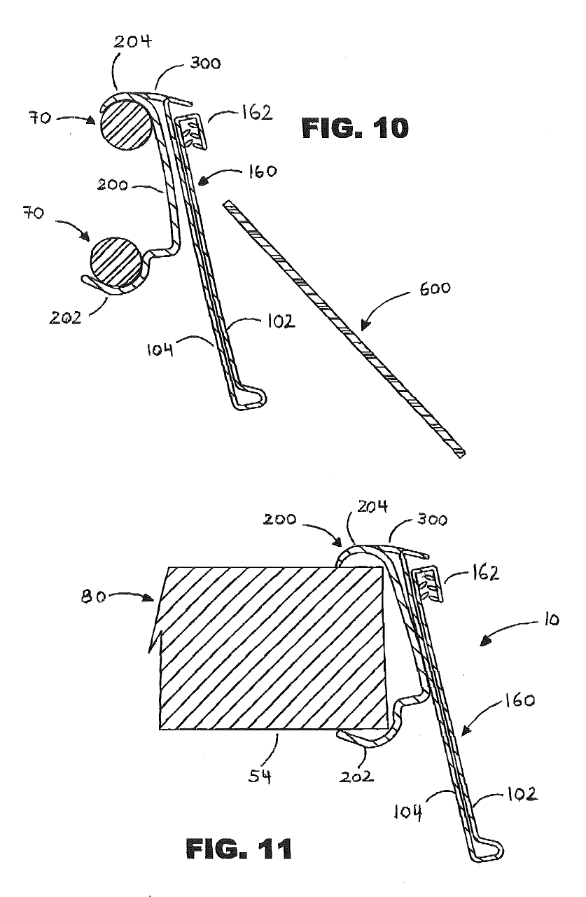

Referring now to the drawings, wherein the showings are for purposes of illustrating several embodiments of the invention only and not for the purposes of limiting same, FIG. 1 refers to a snap-on label holder 10 provided with a front pocket member 100 interconnected by means of a flexible hinge 300 to a rear mounting member 200. Rear mounting member 200 is adapted to be snapped-on to the front edge 52 of a metal, wood or plastic shelf such as a hooked-shaped Hussmann-type metal shelf 50, a Metro-type metal wire shelf 60 (FIG. 10), a plastic shelf (not shown), a wooden shelf 70 (FIG. 11) or shelves of the like.

The front pocket member 100 is comprised of a back panel 104 and a clear front panel 102 forming together an upwardly opening label pocket 110 for holding an information label (not shown). Front pocket member 100 is interconnected by flexible hinge 300 to rear mounting member 200 which can be simply snapped-on to the front hooked-shaped edge 52 of a shelf such as a Hussmann™ metal shelf 50 shown in FIGS. 1, 2, 4, 7 and 9.

Front pocket member 100 may be sized and extruded to any desirable height to provide maximum exposure and display visibility. While recognizing the drawback of prior art label holders which height had to be restricted so as to not interfere with merchandise placed behind them, the label holder of the present invention 10 solves that problem by providing a flexible hinge 300 in the upper portion of the front pocket member 100 so as to pivot freely in relation to rear mounting member 200, thus making pulling out of merchandise placed behind front pocket member 100 easy. Gravity forces will bring front pocket member 100 back to its original downward position.

FIG. 2 shows that prior art label holder 10 requires to be mounted to an intermediary extruded aluminum or plastic price channel 60 which must to be first mounted to the front edge 52 of a Hussmann-like shelf platform 50 before prior art label holder 10 can be mounted. As shown in FIGS. 1, 4, 7, 9, 10 and 11, the label holder 10 of the invention does not require use of intermediary channels 60 and thus eliminates altogether the need for such channels 60. Thus, label holder of the invention 10 may be mounted directly to front edge 52 of any shelf such as a Hussmann-like metal shelf 50, a Metro-type metal wire shelf 70, a wood shelf 80 and other shelves of the like.

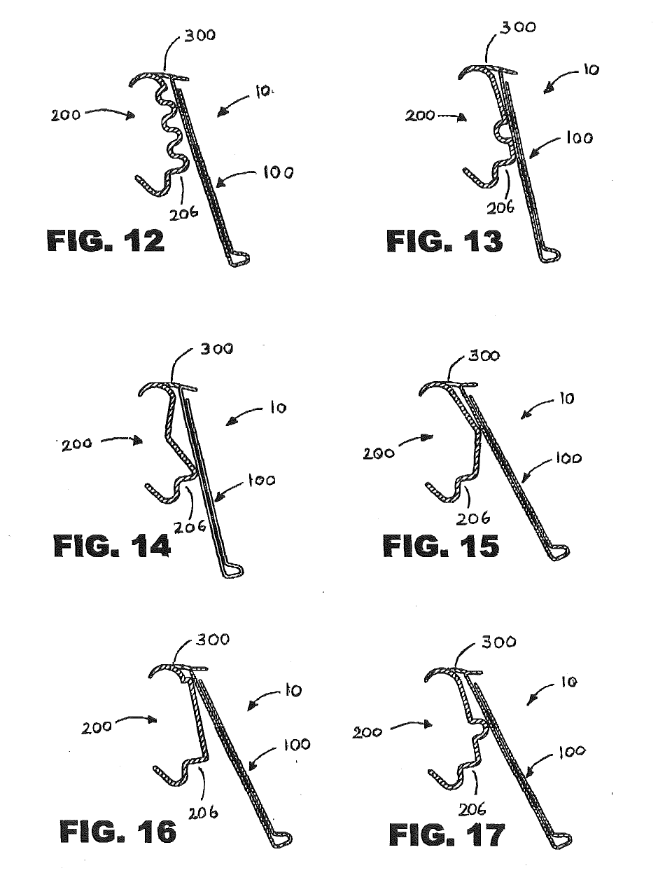

Referring again to FIG. 1, rear mounting member 200 defines an interior region 208 that is flanked between two opposing jaws 202 and 204. Jaws 202 and 204 are adapted to engage grippingly and releasably to retain label holder 10 to shelf edge 52. The rear mounting member 200 comprises a hook-shaped interior region 208 that integrates a spring-bias means 206 that biases said jaws 202 and 204 towards the shelf edge 52 when the rear mounting member 200 is engaged to shelf edge 52. The spring-bias means 206 flanked in-between opposite jaws 202 and 204 may take anyone of the configurations selected from the group consisting of a nose-like shape, a U-shape, a W-shape, a C-shape, a square wave-shape and shapes of the like as shown in FIGS. 1, 12, 13, 14, 15, 16 and 17. Generally, the spring-biased means 206 has a protruded shape that extends inwardly and/or outwardly from said interior region 208.

Rear mounting member 200 is mounted on shelf edge 52 by engaging first a bottom jaw 202, then by applying pressure on the upper portion of the upper jaw 204 so as to snap-fit by urging the two opposite jaws 202 and 204 onto the longitudinal shelf edge 52 of various shelf models such as the Hussmann-like metal shelf platform 50. During mounting, the mounting jaws 202 and 204 resiliently expand and grip over the plat surface of a wooden shelf 80, around the rounded wires of a wire shelf 70 or around the hook-shaped front edge of a Hussmann-like metal shelf 52. As said before, added resiliency is built-in into the generally wavy profile of the rear mounting member 200.

Now referring to FIG. 7, nose-shaped protrusion 206 on the rear mounting member 200 forms further a fulcrum 206 in relation to front label pocket member 100. This fulcrum effect is best utilised when the front clear panel 102 is urged to open by directing a downward and/or rearward pressure (e.g., with a finger 500) on the bottom portion 106 of the front pocket member 100 against fulcrum 206. This fulcrum effect facilitates insertion and replacement of labels (not shown) within the label pocket 110 formed by the front and back panels 102 and 104.

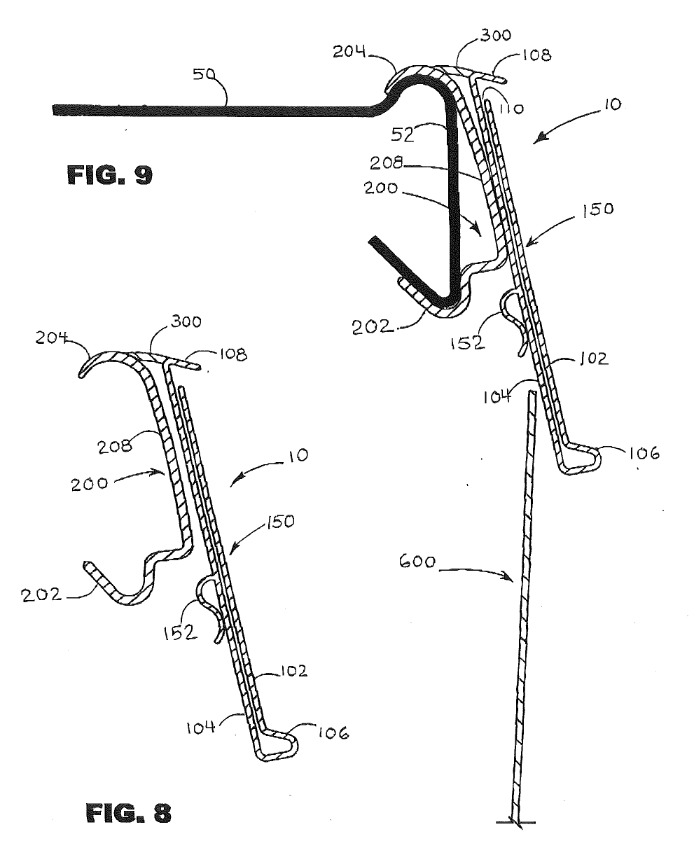

In the second embodiment of the snap-on label holder 10 of the invention, as shown in FIGS. 8 and 9, the label holder 10 has a similar hook-shaped rear mounting member 200 as defined in first embodiment of the invention 10, said rear mounting member 200 comprising an interior region 208 having a nose-shaped 206 configuration flanked between two opposite jaws 202 and 204. Rear mounting member 200 is interconnected by a resilient hinge 300 to a front pocket member 150. Front pocket member 150 comprises a sign clip 152 integrally joined to the back side of the back panel 104 of label holder front pocket member 150. Back panel 104 and front panel 102 forming together a label pocket 110. This second embodiment of the label holder 10 provides support to both a large auxiliary sign card 600 and a conventional price-label (not shown), both being displayed together without obstructing the other.

In the third embodiment of the label holder 10, as shown in FIGS. 10 and 11, the label holder 10 is provided with a similar rear mounting member 200 and a similar flexible hinge 300 than in the first embodiment of the invention. In this embodiment, the front pocket member 160 is provided with a gripper 162 also known as a sign clip. Said gripper 162 is provided at the upper margin of front panel 102 of front pocket member 160 and is integrally joined therein. Such a gripper 162 is known to be an effective fastener for holding large auxiliary sign cards 600.

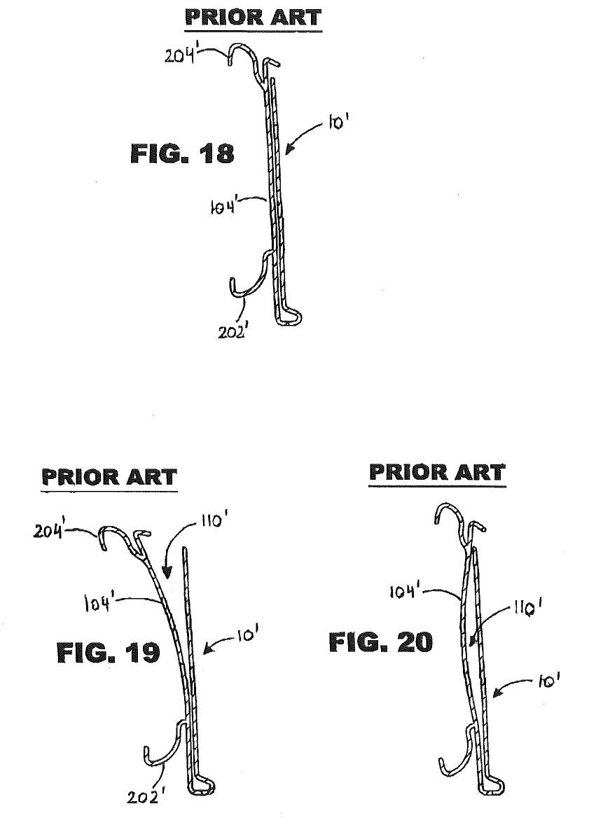

Referring to FIGS. 2, 18, 19 and 20 show how prior art label holder 10′ having generally a same back panel 104′ to function also as a mounting panel is affected by exterior physical forces exercised on jaws 202′ and 204′ when said jaws are engaged to maintain jaw grip to a shelf element 60 (FIG. 2). Such forces create a concave or convex deformation on back panel 104′, thus affecting label readability.

In all embodiments of the present invention, front and rear members 100 and 200 are generally provided as two independent members and remain, at all times as such, free from any physical deformation imposed on anyone of these two members 100,150,160 and 200. They are interconnected by a flexible hinge 300 that does not transfer deformations. Thus the present label holder 10 retains label readability at all times and under all conditions.

Furthermore, flexible hinge 300 interconnects front pocket member 100, 150,160 to rear mounting member 200 so as to permit rotational movement of one member relative to the other member, as shown in FIG. 4.

Front and rear members 100,150,160 and 200 are made by extrusion of rigid plastic but flexible material, whereas flexible hinge 300 is made of flexible resilient material and is co-extruded with front and rear members 100,150,160 and 200.

Label holder 10 of the present invention is adapted to fit over a shelf edge for all or part of its length. The front clear panel 102 is fabricated of an extrusion of semi-rigid plastic that has sufficient transparency to allow easy visibility of the label and the operation of a bar code scanner through the plastic. The upper edge of the back panel 104 terminates in an outwardly-facing lip 108, and is adapted to protect labels against dust.

The spring-bias means 206 allows to firmly snap-on any length of the label holder 10 at any desired position on a shelf edge, said label holder 10 comprising a front pocket member 100,150,160 optionally extruded to different heights, thus providing a choice of different label heights on a same shelf 50,70,80.

While a user is easily able to place or retract a sign behind the front panel 102, a measure of force is required to retract the sign sufficiently enough to discourage unauthorized, casual individuals.

The design of the snap-on label holder 10 allows the front panel 102 to be retracted without causing the rear mounting member 200 to weaken its grip on the shelf edge 52.

In use, the label holder 10 is installed to a shelf edge 52 by snap-fitting the bottom jaw 202 of the snap-on rear mounting member 200 over the lower lip 54 of a shelf edge 52. Labels, price tickets, point-of-sale displays, and the like may then be inserted between front panel 102 and back panel 104 by directing downward and/or rearward pressure on the bottom portion 106 of the label holder 10 against fulcrum 206 as seen in FIG. 7.

The resiliency of the label holder 10 requires the user to pull firmly to retract the label holder 10; this ensures both that the display (not shown) will be firmly held in position by the label holder 10, and makes it more difficult for unauthorized individuals to tamper with the displays. As well, the resiliency of the material allows the label holder 10 to grip each sign independently of its neighbors, and to retain a sign in its place when a sign is retracted for the removal of a neighboring sign. The plastic materials selected for fabrication of the label holder 10 must be sufficiently resilient to allow the clear front panel 102 to flex sufficiently to meet some of the above requirements, yet be sufficiently rigid to firmly grip a sign and make unauthorized removal difficult.

When it is desired to replace a label holder 10, for example when it becomes damaged, the rear mounting member 200 may be released from the shelf edge 52 by a downwardly pulling or twisting motion, and replaced with a new label holder 10.

The present invention has been described by way of preferred embodiments thereof. However, it will be apparent to those skilled in the art that variations may be made to the embodiments described herein, without departing from the spirit and scope of the invention, as defined by the appended claims.

Embodiments of the invention in which an exclusive property or privilege is claimed are defined as follows:

What is claimed is:

1. A label holder adapted for snap-on engagement to a longitudinal edge of a shelf, said label holder comprising:
a front hingeable label pocket member comprising a front clear panel connected at its lower edge to a back panel
a rear generally hook-shaped mounting member that defines
an interior region flanked between two opposite jaws, said jaws adapted to be snapped-on grippingly to said shelf edge,
said interior region having a sinuous profile
said sinuous profile acting first as a spring-bias means to bias said jaws towards said shelf edge when said mounting member is engaged to said shelf edge,
and said sinuous profile acting as a fulcrum relative to said front pocket member; and
a flexible hinge interconnecting flexibly upper portions respectively of said front pocket member to said rear mounting member.

2. The snap-on label holder of claim 1 wherein said sinuous profile in said interior region is selected from the group of profiles consisting of a protruded nose-shape, a wave-shape, a C-shape, an S-shape, a square wave-shape profile and combinations thereof.

3. The snap-on label holder of claim 1 wherein said hook-shaped mounting member is mountable directly to shelves selected from the group consisting of a Hussmann-like metal shelf, of a metal wire shelf, of a plastic shelf and of a wooden shelf.

4. The snap-on label holder of claim 1 wherein resiliency provided in said flexible hinge interconnecting said front label pocket to said rear mounting member allows said label holder to retain label readability at all times, whereby deformations imposed on jaws of said rear mounting member when said mounting member is engaged on a shelf are not transferred to the front label pocket.

5. The snap-on label holder of claim 1 wherein said fulcrum in said rear mounting member provides a pivot against which said front pocket member may be pushed against to assist pocket opening.

6. The snap-on label holder of claim 1 wherein said flexible hinge positioned on said front pocket member allows for said pocket member to be sized and extruded to any desired height; and whereby hinging of the front pocket member allows easy access to and removal of merchandise placed behind said label holder.

7. A label holder adapted for snap-on engagement to a longitudinal edge of a shelf, said label holder comprising:
a front hingeable label pocket member comprising a front clear panel connected at its lower edge to a back panel,
said back panel comprising a sign clip integrally joined therein;
a rear generally hook-shaped mounting member that defines
an interior region flanked between two opposite jaws, said jaws adapted to be snapped-on grippingly to said shelf edge,
said interior region having a sinuous profile
said sinuous profile acting first as a spring-bias means to bias said jaws towards said shelf edge when said mounting member is engaged to said shelf edge,
and said sinuous profile acting as a fulcrum relative to said front pocket member; and
a flexible hinge interconnecting flexibly upper portions respectively of said front pocket member to said rear mounting member.

8. A label holder adapted for snap-on engagement to a longitudinal edge of a shelf, said label holder comprising:
a front hingeable label pocket member comprising a front clear panel connected at its lower edge to a back panel, said front clear panel comprising a gripper at its upper margin integrally joined therein;
a rear generally hook-shaped mounting member that defines
an interior region flanked between two opposite jaws, said jaws adapted to be snapped-on grippingly to said shelf edge,
said interior region having a sinuous profile,
said sinuous profile acting first as a spring-bias means to bias said jaws towards said shelf edge when said mounting member is engaged to said shelf edge,
and said sinuous profile further acting as a fulcrum relative to said front pocket member; and
a flexible hinge interconnecting flexibly upper portions respectively of said front pocket member to said rear mounting member.
